(19) United States
(12) Patent Application Publication
(10) Pub. No.: US 2024/0001851 A1
(43) Pub. Date: Jan. 4, 2024

(54) Truck Camera and Safety System

(71) Applicant: Daniel P. Burbank, Moultonborough, NH (US)

(72) Inventor: Daniel P. Burbank, Moultonborough, NH (US)

(21) Appl. No.: 18/463,045

(22) Filed: Sep. 7, 2023

Related U.S. Application Data
(63) Continuation-in-part of application No. 17/692,712, filed on Mar. 11, 2022, now Pat. No. 11,787,333.
(60) Provisional application No. 63/159,723, filed on Mar. 11, 2021.

(51) Int. Cl. B60R 1/29; G06V 20/56; G06V 20/59; H04N 23/61; H04N 23/90

(52) U.S. Cl. CPC B60R 1/29; G06V 20/56; G06V 20/59; H04N 23/61; H04N 23/90; B60R 2300/8006

(57) ABSTRACT

A truck camera and safety system to prevent harm from being done to one or more individuals who accidentally fall into a hopper. The overall system includes a truck having a lift arm mechanism and a hopper. At least one camera and temperature sensor are disposed within the hopper. A control module is operably connected to cameras and a temperature sensor, as well as to one or more vehicle systems, via a vehicle control interface disposed within the driver's cab of the truck. The control module includes a processor, a non-transitory computer readable medium operatively connected to the processor, and a logic stored in the non-transitory computer readable medium that, when executed by the processor, causes the system to detect, via the temperature sensor, the temperature within the hopper. If the temperature detected is above a predetermined threshold temperature, the overall system is deactivated.

### CROSS-REFERENCE TO RELATED APPLICATIONS

This Continuation-In-Part application claims the benefit of U.S. Provisional Application No. 63/159,723 filed on Mar. 11, 2021 and U.S. Non-Provisional application Ser. No. 17/692,712 filed on Mar. 11, 2022. The above identified patent applications are herein incorporated by reference in their entirety to provide continuity of disclosure.

### BACKGROUND OF THE INVENTION

The present invention relates to a camera and safety system for a truck. More specifically, the present invention includes a camera and safety system that is configured to detect the presence of one or more human beings within a truck hopper, alert the driver, and automatically deactivate various systems in order to prevent injury or death of the one or more persons in the hopper. A thermal imaging system for the truck will increase overall safety by immediately notifying the truck operator of the presence of one or more individuals in the truck hopper. The present invention may be adapted for use in commercial vehicles, such as mail and package delivery trucks, for example.

The main purpose of the present invention is to save lives and property. A camera system and safety system with thermal imaging capabilities as well as audio and video capabilities will help reduce the number of accidents. It will also potentially prevent the loss of trucks that are involved in such accidents. In view of the above concerns, it is desirable to provide a truck camera safety system that provides audible and visual alerts for drivers that will notify drivers of individuals in harm's way.

In light of the devices disclosed in the known art, it is submitted that the present invention substantially diverges in design elements from the known art and consequently it is clear that there is a need in the art for an improvement to existing camera systems and safety systems for trucks and other similar commercial vehicles. In this regard the present invention substantially fulfills these needs.

### SUMMARY OF THE INVENTION

The present invention provides a truck camera and safety system, which may be utilized to increase overall safety by notifying operators of individuals being in the hopper, as well as by automatically stopping the truck's systems when the individual is detected by the present system. In general, the truck camera and safety system includes a truck having a lift arm mechanism and a hopper. At least one camera is disposed within the hopper, which is designed to provide full coverage of the area within the hopper. At least one temperature sensor is also disposed within the hopper, which may be separate from the camera, or included in the case of using an infrared camera.

The system further includes a control module operably connected to the cameras and the temperature sensor. The control module is also operably connected to one or more vehicle systems via a vehicle control interface, which is housed within a display and control mechanism situated within the operator's cabin. The control module includes a processor, a non-transitory computer readable medium operatively connected to the processor, and a logic stored in the non-transitory computer readable medium that, when executed by the processor, causes the system to perform a method. The method includes detecting, via the temperature sensor, the temperature within the hopper. If the temperature detected is above a predetermined threshold temperature, then the control module communicates with the vehicle systems to automatically deactivate the system, which will prevent harm from being done to the individual within the hopper and to prevent damage from being done to the vehicle. The control module may also control other systems, such as an audible alarm and visual display, which will further alert the driver to the presence of an individual within the hopper.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the truck camera and safety system.

FIG. 2 shows a top plan view of an embodiment of the truck camera and safety system.

FIG. 3 shows a diagram of the components of an embodiment of the truck camera and safety system.

### DETAILED DESCRIPTION OF THE INVENTION

According to some embodiments, the operations, techniques, and/or components described herein may be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g., a memory, wherein implementation of the logic by the processor on the electronic device provides the electronic device with the function of a special-purpose computing device.

In the interests of economy, the present disclosure refers to “a microcontroller”, “a sensor”, “a camera”, “a computer-readable medium,” “a processor,” “a memory”, “a logic”, and so on. However, this should not be read as limiting in any way as the present disclosure contemplates embodiments of the present invention utilizing “one or more computer-readable media” “one or more processors” and so on. Unless specifically limited to a single unit, “a” is intended to be equivalent to “one or more” throughout the present disclosure. As used herein, the term “processor” may refer to any electronic circuit which performs operations on some external source. As used herein, the term “logic” may include any combination of computer software instructions, integrated circuit-based logic gates, switch or junction-based logic gates, etc. As used herein, the term “memory” may refer to any non-transitory computer readable medium, including but not limited to simple circuit states via logic gates or switch positions, as well as solid state computer readable storage.

According to some embodiments, the operations, techniques, and/or components described herein may be implemented by an electronic device, which may include any combination of digital and analogue circuitry, as well as one or more special-purpose computing devices. The special-purpose computing devices may be hard-wired to perform the operations, techniques, and/or components described herein, or may include digital electronic devices such as one or more application-specific integrated circuits (ASICs) or field programmable gate arrays (FPGAs) that are persistently programmed to perform the operations, techniques and/or components described herein, or may include one or more general purpose hardware processors programmed to perform such features of the present disclosure pursuant to program instructions in firmware, memory, other storage, or a combination. Such special-purpose computing devices may also combine custom hard-wired logic, ASICs, or FPGAs with custom programming to accomplish the technique and other features of the present disclosure. The special-purpose computing devices may be desktop computer systems, portable computer systems, handheld devices, networking devices, or any other device that incorporates hard-wired and/or program logic to implement the techniques and other features of the present disclosure.

Reference is made herein to the attached drawings Like reference numerals are used throughout the drawings to depict like or similar elements of the truck camera and safety system. For the purposes of presenting a brief and clear description of the present invention, a preferred embodiment will be discussed as used for a front-loading truck, specifically to detect individuals who are accidentally dumped into the hopper of the truck. However, other embodiments are contemplated, including different types of trucks, as well as any other suitable commercial or larger vehicle, in which such safety systems would be desirable.

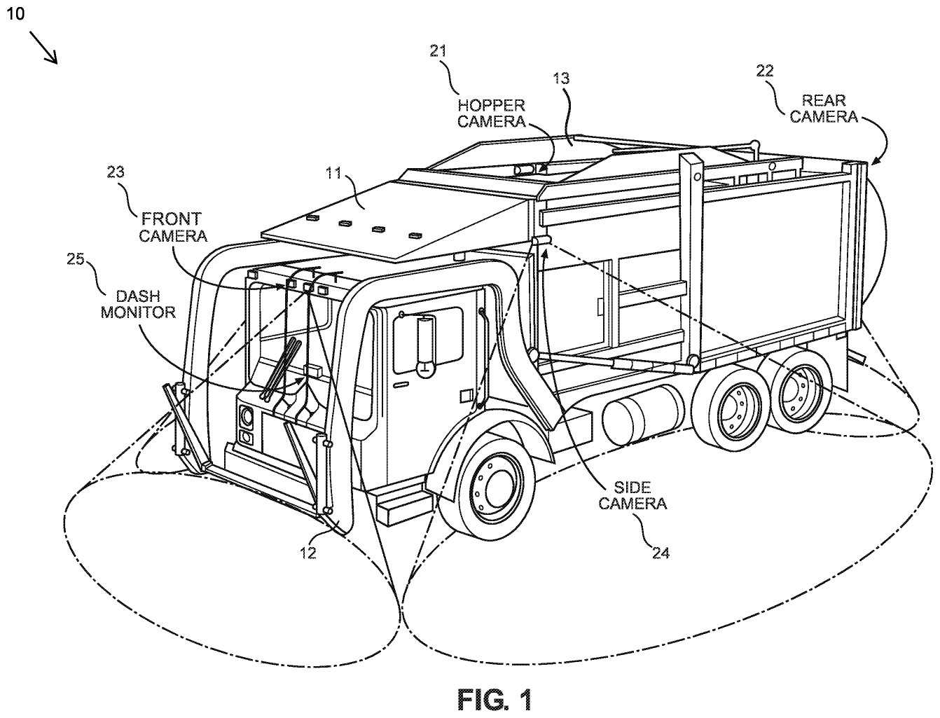

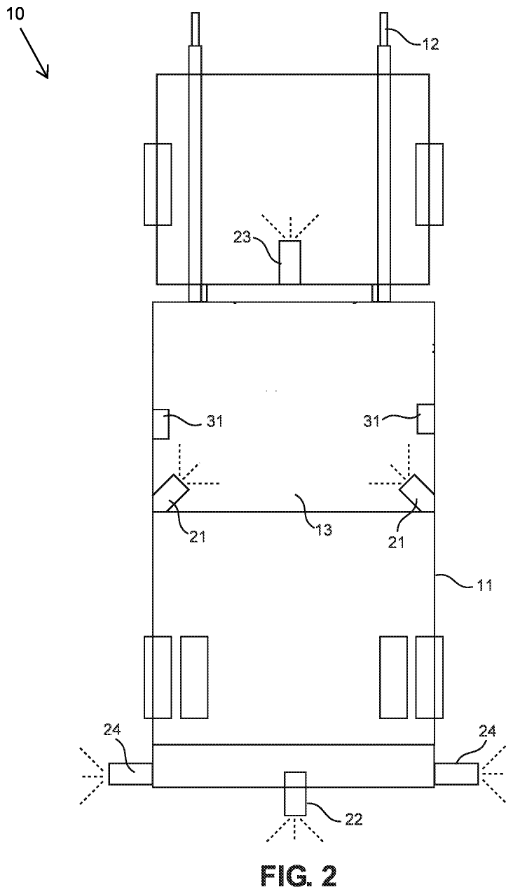

Referring now to FIG. 1 there is shown a perspective view of an embodiment of the truck camera and safety system 10 (hereafter known as “system”). The system 10 generally includes a truck 11 having a lift arm mechanism 12 and a hopper 13, which is visible in FIG. 2. While a front-loading lift arm mechanism 12 is shown, the present system 10 may be utilized with any type of truck that includes any possible commercial vehicle. In the shown embodiment, at least one camera 21 is disposed within the hopper 13. The system 10 further includes exterior cameras for additional monitoring and safety. In the shown embodiment, the exterior cameras 21 include a rear camera 22 mounted to a rear end of the truck 11, a front camera 23 mounted to a front end of the truck 11, and a pair of side cameras 24, each side camera 24 mounted to a side of the truck 11.

All of the cameras 21, 22, 23, 24 are configured to record and display video via a vehicle control interface, which includes a dash monitor 25 disposed within the vehicle cabin. The cameras 24 are numbered and positioned such that a full 360 degree view of the surroundings of the truck 11 may be monitored by the operator. The cameras 24 may be positioned in such away that is advantageous to keeping them operating as intended. For example, the front camera 23 may be positioned under the upper cabin shroud, to prevent debris and trash from accidentally contacting and damaging the front camera 23. The remaining cameras 23 may include similar advantageous positioning that uses elements of the truck to shield the cameras 23. In other embodiments, the cameras 23 include additional shielding elements attached to their housings.

Referring now to FIG. 2, there is shown a top plan view of an embodiment of the truck camera and safety system 10. Further, the hopper cameras 21 are adapted to provide a view of the entire interior area of the hopper 13. The system 10 further includes temperature sensors 31 disposed within the hopper 13, which are configured to detect the temperature of items falling into the hopper 13 as the lift arms 12 dump a container into the hopper 13. In some embodiments, the temperature sensors 31 are independent sensors, while in other embodiments, the temperature sensors 31 are embedded within the hopper cameras 21, in that the hopper cameras 21 may be infrared cameras 21A. The front 23, rear 22, and side 24 cameras are shown in one position, but may occupy any desired position on the body of the truck.

The hopper cameras 21 and any separate temperature sensor modules 31 ideally will be located somewhere beneath the cab protector portion of the vehicle. In this way, the camera 23 is protected from damage as debris is dumped into the hopper 13. Preferably, the front camera 23 is positioned inside of the cab on the windshield. Additional shrouds and guards may be included to protect the cameras 21, 23 from snow, ice, and other cold weather hazards. In the shown embodiment, the hopper 13 includes at two cameras 23 adapted to provide a total image of the interior of the hopper 13 for the operator via the display screen of the vehicle control interface.

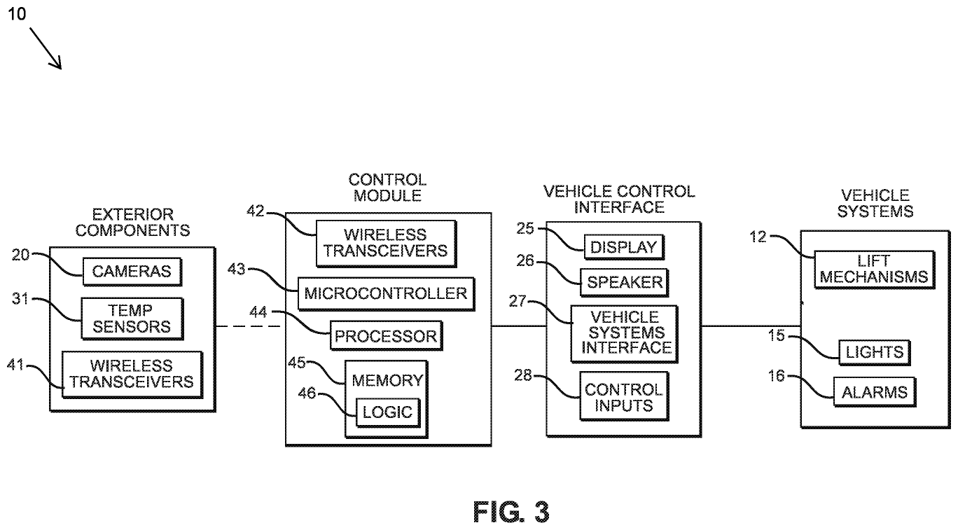

Referring now to FIG. 3, there is shown a diagram of the components of an embodiment of the truck camera and safety system 10. The exterior system components include all of the cameras 20, which includes the exterior cameras and hopper cameras 21, as well as any independent temperature sensors 31. Each camera 20, 21 and temperature sensor 31 includes an independent power supply in some embodiments, but may be hard wired to a single power supply in other embodiments, which may be the vehicle battery or a separate onboard power supply for the system 10. Further, each camera 20, 21 and sensor 31 may include a wireless transceiver 41 for communicating wirelessly with a control module's wireless transceiver 42 via a network such as a LAN, WLAN, Bluetooth connection, Wi-Fi connection, or any other suitable wireless communications protocols. Some embodiments may instead include all hard-wired connections between components of the system 10.

The control module is operably connected to the cameras 20 and the temperature sensors 31 via wired or wireless connections. Similarly, the control module is also operably connected to one or more vehicle systems via a vehicle control interface. The vehicle control interface is preferably a single control unit that is disposed within the cabin of the vehicle. The vehicle control interface includes a display screen 25 that displays status alerts, images from the exterior and hopper cameras 20, and other information. The vehicle control interface may further include a speaker 26 for emitting audible alarms, as well as input controls 28 such as buttons, touchscreens, keypads, or the like for controlling the system's operation. In some embodiments, the main control module is integrated within the housing of the vehicle control interface.

The control module further includes a processor 44, a non-transitory computer readable medium operatively connected to the processor, which may be a flash memory, hard disc, or any other suitable memory type, and a logic 46 stored in the non-transitory computer readable medium that, when executed by the processor 44, causes the system 10 to perform a method.

The method includes detecting, via the temperature sensors 31, a temperature within the hopper 13. If the temperature detected is above a predetermined threshold temperature, such that there is a likelihood a person is currently in the hopper 13, then the system 10 automatically deactivates the overall system 10. This will prevent injury from occurring to the individual in the hopper 13, and further prevent damage from occurring to the truck itself.

Other vehicle systems may be automatically controlled in order to increase the safety provided by the present system 10. For example, the truck camera and safety system 10 further includes an in-vehicle alarm, such that the system 10 activates the in-vehicle alarm, emitting a sound through the vehicle control interface speaker 26 if the temperature detected is above the predetermined threshold temperature. The system 10 may further be configured to operate the vehicle's own alarm 16, horn, or other sounding devices, in order to alert the operator and surrounding individuals of the detected danger. In other embodiments, the further deactivates the lift arm mechanism 12 if the temperature detected is above a predetermined threshold temperature. Likewise, the system 10 may further be configured to activate one or more vehicle lights if the temperature detected is above a predetermined threshold temperature. These additional alert methods ensure that the vehicle operator is notified when an individual accidentally falls within the hopper 13 or otherwise becomes dangerously close to the exterior of the vehicle.

In some embodiments, the control module further comprises an image recognition module, wherein the image recognition module is configured to scan recorded images from the exterior and hopper cameras 21, and automatically detect the presence of an individual within the hopper 13 or within the viewing area of the exterior cameras 20. This may further enhance the safety of the present system, by providing an additional mechanism for detecting when individuals are too close to the vehicle or if they are accidentally in the hopper 21. In this way, the present invention greatly enhances the safety of current trucks and other commercial vehicles, which will prevent individuals from being injured by the trucks and prevent the trucks themselves from becoming damaged.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, and all equivalent relationships to those illustrated in the drawings and described in the specification are intended to be encompassed by the present invention.

Therefore, the foregoing is considered as illustrative only of the principles of the invention. Further, it is not desired to limit the invention to the exact construction and operation shown and described, and accordingly, all suitable modifications and equivalents may be resorted to, falling within the scope of the invention.

I claim:

1) A truck camera and safety system, comprising:
a truck having a lift arm mechanism and a hopper;
a camera disposed within the hopper;
a temperature sensor disposed within the hopper; and
a control module operably connected to the camera and the temperature sensor, the control module operably connected to one or more vehicle systems via a vehicle control interface.

2) The truck camera and safety system of claim 1, wherein the truck includes an in-vehicle alarm.

3) The truck camera and safety system of claim 1, wherein the truck is a mail delivery truck.

4) The truck camera and safety system of claim 1, wherein the truck is a package delivery truck.

5) The truck camera and safety system of claim 1, wherein the camera in the hopper comprises at least two cameras adapted to provide a total image of an interior of the hopper for an operator via the display screen of the vehicle control interface.

6) The truck camera and safety system of claim 1, wherein the control module further comprises an image recognition module, wherein the image recognition module scans recorded images from the hopper camera and is adapted to automatically detect a presence of a person within the hopper.

7) The truck camera and safety system of claim 6, wherein the image recognition module scans recorded images from the exterior camera and is adapted to automatically detect the presence of the person within a viewing field of the exterior cameras.

8) The truck camera and safety system of claim 1, wherein the control module is integrated within the housing of the vehicle control interface.

9) The truck camera and safety system of claim 1, wherein the control module detects, via the temperature sensor, the temperature within the hopper, if the temperature detected is above a predetermined threshold temperature, then the truck camera and safety system is deactivated.

10) A method for utilizing a truck camera and safety system, comprising the steps of:
detecting a temperature within a hopper;
determining if the temperature within the hopper is above a predetermined threshold temperature; and
deactivating the truck camera and safety system if the temperature within the hopper is above the predetermined threshold temperature.

11) The method according to claim 10, wherein the detecting step includes the temperature is detected within the hopper via a plurality of temperature sensors of the truck camera and safety system.

12) The method according to claim 10, wherein the determining step includes if the temperature within the hopper is above the predetermined threshold temperature, then there is a likelihood that a person is currently in the hopper.

13) The method according to claim 12, wherein the deactivating step includes preventing injury from occurring to the person within the hopper and further preventing damage from occurring to the truck itself.

14) A non-transitory computer storage media having instructions stored thereon which, when executed, execute a method comprising the steps of:
detecting a temperature within a hopper;
determining if the temperature within the hopper is above a predetermined threshold temperature; and
deactivating the truck camera and safety system if the temperature within the hopper is above the predetermined threshold temperature.

15) The non-transitory computer storage media according to claim 14, wherein the detecting step includes the temperature is detected within the hopper via a plurality of temperature sensors of the truck camera and safety system.

16) The non-transitory computer storage media according to claim 14, wherein the determining step includes if the temperature within the hopper is above the predetermined threshold temperature, then there is a likelihood that a person is currently in the hopper.

17) The non-transitory computer storage media according to claim 16, wherein the deactivating step includes preventing injury from occurring to the person within the hopper and further preventing damage from occurring to the truck itself.
